(19) United States
(12) Patent Application Publication
(10) Pub. No.: US 2026/0260639 A1
(43) Pub. Date: Sep. 3, 2026

(54) KEYBOARD DEVICE FOR KEYBOARD INSTRUMENT AND KEY FOR KEYBOARD DEVICE

(71) Applicant: KABUSHIKI KAISHA KAWAI GAKKI SEISAKUSHO, Hamamatsu-shi (JP)

(72) Inventor: Satoshi KITO, Hamamatsu-shi (JP)

(21) Appl. No.: 19/652,638

(22) Filed: Apr. 20, 2026

Related U.S. Application Data
(62) Division of application No. 18/189,143, filed on Mar. 23, 2023.

(30) Foreign Application Priority Data
Mar. 30, 2022 (JP) 2022-056844
Mar. 30, 2022 (JP) 2022-056845

(51) Int. Cl. G10H 1/34

(52) U.S. Cl. CPC G10H 1/346; G10H 2220/221; G10H 2220/265

(57) ABSTRACT

A keyboard device for a keyboard includes a hammer vertically pivotally moved in a manner interlocked with a key having been depressed, and a cushion provided below the hammer, the hammer contacting the cushion from above when the hammer having been pivotally moved upward in accordance with depression of the key returns to an original position in accordance with release of the key. The hammer includes a plurality of protrusions formed at respective spaced location in a rearward sequence from a hammer support shaft, such that they each extend downward. The cushion is formed by a plurality of cushions sequentially contacted by the plurality of protrusions, when the hammer contacts the cushion from above, in order from a protrusion closest to the hammer support shaft toward a protrusion remotest from the hammer support shaft.

### BACKGROUND OF THE INVENTION

### CROSS-REFERENCE TO RELATED APPLICATIONS

This application is a divisional of U.S. Patent Application No. 18/189,143, filed on March 23, 2023, which claims priority to Japanese Patent Application Number 2022-056844, filed on March 30, 2022, and Japanese Patent Application Number 2022-056845, filed on March 30, 2022, the entire content of each of which is incorporated herein by reference.

### FIELD OF THE INVENTION

The present invention relates to a keyboard device which is applied to a keyboard instrument, such as an electronic piano, and includes a hammer pivotally moved in a manner interlocked with key depression, and relates to a key for a keyboard device which is applied to a keyboard instrument, such as an electronic piano, and more particularly to a key for a keyboard device, which has a weight mounted inside the key.

### Description of the Related Art

Conventionally, as this type of a keyboard device, there has been known, for example, one disclosed in Japanese Laid-Open Patent Publication (Kokai) No. 2014-10374. In this keyboard device, hammers are pivotally movably provided below keys extending in a front-rear direction, on a key-by-key basis. In a key-released state, each hammer extends in the front-rear direction in a state inclined downward toward the rear such that a rear end thereof contacts a stopper from above. This stopper is formed by a stopper rail horizontally extending in a left-right direction, and a buffer formed on an upper surface of the stopper rail and having a predetermined rectangular shape in transverse cross-section over the entire longitudinal length thereof.

On the other hand, conventionally, there has been known a key for a keyboard device, which is configured to have a weight mounted in a hollow inside of the key so as to adjust touch feeling of the key. For example, in Japanese Laid-Open Patent Publication (Kokai) No. 2017-44989, a key for a keyboard device is disclosed which has a hole portion open downward formed in a key body portion, and protruding falling-off prevention portions and displacement suppression portions formed inside the hole portion, for having an elastically deformable weight pushed into the hole portion, thereby preventing falling off the weight and suppressing vertical looseness of the same.

In the keyboard device including the stopper described above as disclosed in Japanese Laid-Open Patent Publication (Kokai) No. 2014-10374, when one of the keys is depressed, a hammer associated with the key is pivotally moved in a predetermined direction, and a rear end of the hammer moves upward from the stopper. Then, when the key is released, the hammer is pivotally moved in a direction opposite to the above-mentioned direction, and the rear end of the hammer moves into contact with the stopper from above.

In the keyboard device described above, only one stopper is formed at a location corresponding to the rear end of the hammer. In this case, the rear end of the hammer being pivotally moved is the remotest from a rotational shaft of the hammer, so that kinetic energy of the hammer moving into contact with the stopper is large. Therefore, when the hammer contacts the stopper, the hammer is liable to bounce, and it sometimes takes a long time before the hammer completely stops. As a consequence, during time until the hammer completely stops, there is a possibility that so-called bouncing is caused to vertically vibrate an upper surface of the key associated with the hammer. Further, there is a possibility that since the rear end of the hammer having large kinetic energy contacts the single stopper, noise is liable to be generated.

On the other hand, in the key of the keyboard device disclosed in Japanese Laid-Open Patent Publication (Kokai) No. 2017-44989, to hold the weight inside the hole portion of the key body portion, a plurality of the protruding falling-off prevention portions and a plurality of the displacement suppression portions are provided. This complicates the structure of a mold for molding the key body portion, and increases manufacturing costs.

Further, conventionally, there has been known a key for a keyboard device, which has woody boards attached to sides of a key body made of resin so as to impart a woody feeling to the key at a low cost. Normally, such a key is configured such that a top portion of the key body is caused to protrude laterally from respective side portions thereof such that upper end surfaces of the woody boards are prevented from being exposed to the outside, to thereby cover the upper end surfaces of the woody boards. This, however, causes a problem that in the case of the key body having such a shape, unevenness of cooling rate is caused in the top portion during molding of the key body, which causes non-uniform contraction of the resin material, so that molding defects called sink marks are liable to be generated.

### SUMMARY OF THE INVENTION

It is a first object of the present invention to provide a keyboard device for a keyboard instrument, which is capable of suppressing occurrence of bouncing of a key by suppressing bouncing of a hammer when the hammer pivotally moved in a manner interlocked with key depression returns to its original position, and is capable of suppressing generation of noise by the hammer.

It is a second object of the present invention to provide a key for a keyboard device, which is capable of not only firmly holding a weight accommodated inside a key body but also simplifying a mold for molding the key body, thereby suppressing increase in manufacturing costs, and a key for a keyboard device, which is capable of preventing generation of sink marks on a top portion of a key body during molding of the key body.

To attain the above first object, in a first aspect of the present invention, there is provided a keyboard device for a keyboard instrument, including a keyboard chassis, a key extending in a front-rear direction and disposed on the keyboard chassis, a hammer extending in the front-rear direction and being pivotally supported, below the key, on the keyboard chassis, via a hammer support shaft, the hammer being vertically pivotally moved in a manner interlocked with the key which has been depressed, and a cushion provided below the hammer and having the hammer placed thereon in a key-released state, the hammer contacting the cushion from above when the hammer having been pivotally moved upward in accordance with depression of the key returns to an original position in accordance with release of the key, wherein the hammer includes a plurality of protrusions formed at respective spaced locations in a rearward sequence from the hammer support shaft such that the plurality of protrusions each protrude downward, and wherein the cushion is formed by a plurality of cushions associated with the plurality of protrusions, respectively, the plurality of protrusions sequentially contacting, when the hammer contacts the cushion from above, the plurality of cushions associated therewith, respectively, in order from a protrusion closest to the hammer support shaft toward a protrusion remotest from the hammer support shaft.

With this construction, when the hammer having been pivotally moved upward in accordance with depression of the key returns to its original position in accordance with release of the key, the hammer contacts the cushion from above. Further, the hammer is provided with the plurality of protrusions formed at respective spaced locations in a rearward sequence from the hammer support shaft such that the plurality of protrusions each extend downward. On the other hand, the cushion is formed by the plurality of cushions associated with the plurality of protrusions, respectively. When the plurality of protrusions of the hammer contact the plurality of cushions, respectively, the protrusions contact respective associated ones of the cushions in order from one closest to the hammer support shaft toward one remotest from the hammer support shaft. With this, kinetic energy of the hammer being pivotally moved is progressively reduced by the plurality of cushions, whereby it is possible to prevent the hammer from bouncing when all the protrusions of the hammer contact the cushions. As a consequence, even in a case where the key is configured to be interlocked with the hammer, it is also possible to suppress occurrence of bouncing of the key. Further, when the hammer contacts the cushion, as described above, the hammer sequentially contacts the plurality of cushions, whereby it is possible to progressively reduce the speed and momentum of the hammer being pivotally moved, so that compared with the conventional keyboard device in which a hammer contacts a single stopper, it is possible to suppress generation of noise.

Preferably, at least one of the plurality of protrusions is formed into a shape tapered downward.

With the construction of this preferred embodiment, at least one of the protrusions is formed into a shape tapered downward, so that when the protrusions of the hammer contact associated ones of the cushions from above, it is possible to bring the protrusions into contact with the associated cushions such that contact areas between the protrusions and the cushions are progressively increased. With this, compared with a case where contact areas formed when the hammer contacts the cushions are large from the beginning, it is possible to suppress generation of noise when the hammer contacts the cushions.

Preferably, each cushion is formed of an elastic material that has lower resilience as the cushion is closer to the hammer support shaft.

With the construction of this preferred embodiment, the cushions contacted by the protrusions of the hammer, respectively, are each formed of an elastic material that has lower resilience as the cushion is closer to the hammer support shaft, so that it is possible to progressively reduce the kinetic energy of the hammer being pivotally moved, while effectively suppressing generation of noise when the protrusions contact the cushions, respectively. This makes it possible to effectively suppress generation of noise and occurrence of bouncing of the key when the hammer contacts the cushions.

Preferably, the hammer includes a hammer body made of a synthetic resin, extending in the front-rear direction, and pivotally supported on the hammer support shaft, and a weight made of a metal and formed such that the weight extends in the front-rear direction, the weight being mounted on a rear portion of the hammer body and extending rearward from a rear end of the hammer body, and the hammer body and the weight are provided with at least one of the plurality of protrusions.

With the construction of this preferred embodiment, in the hammer including the hammer body made of a synthetic resin and the weight made of a metal, the hammer body and the weight are provided with at least one of the protrusions that contact the cushions, respectively. With this, for cushions contacted by the protrusion of the hammer body and that of the weight, by employing respective elastic materials suitable for the hammer body and the weight, it is possible to excellently reduce the impact of the hammer when the hammer contacts the cushions.

To attain the above second object, in the second aspect of the present invention, there is provided a key for a keyboard device, including a key body made of resin, the key body having at least a top portion and a pair of side portions and formed into a hollow shape open downward, the key body extending a predetermined length in a front-rear direction, and a weight formed of an elastically deformable material and accommodated in a predetermined position inside the key body having the hollow shape, wherein the key body has one or a plurality of grooves extending in the front-rear direction, in an inner surface of each of the pair of the side portions, and wherein the weight has one or a plurality of engagement protrusions each formed at a location opposed to the one or each of the plurality of grooves when the weight is in the predetermined position, the one or each of the engagement protrusions being engaged with the one or each of the plurality of grooves, respectively, thereby holding the weight inside the key body.

With this construction, the one or each of the grooves extending in the front-rear direction is formed in the inner surface of each of the side portions of the key body that has the hollow shape open downward. The weight has the one or each of the engagement protrusions formed at the location opposed to the one or each of the grooves when the weight is in the predetermined position inside the key body, and hence when the weight is accommodated in the predetermined position inside the key body, the engagement protrusion(s) is/are engaged with the groove(s), respectively, whereby it is possible to firmly hold the weight inside the key body.

Further, since the weight can be held only by the one or each of the grooves formed in the inner surfaces of the side portions, there is no need to provide a plurality of protruding falling-off prevention portions or the like, whereby the mold for molding the key body can be simplified, thereby making it possible to suppress increase in manufacturing costs.

Preferably, the one or each of the plurality of grooves is formed in an uppermost portion of each of the pair of the side portions, and the uppermost portion of each of the pair of the side portions is formed to have a thickness dimension smaller than a thickness dimension of the top portion of the key body.

With the construction of this preferred embodiment, the one or each of the grooves is formed in the uppermost portion of each of the pair of the side portions of the key body, such that the thickness of the side portion at the uppermost portion where the groove is formed is smaller than the thickness of the top portion of the key body. With this, for example, even when the key has a structure in which the woody boards are attached to the side portions of the key body, and to cover upper end surfaces of the woody boards, left and right ends of the top portion are formed to protrude laterally, a difference in the thickness between portions of the top portion continuous with the side portions, and the other portions of the top portion is made very small, so that a difference in the cooling rate therebetween becomes difficult to be caused during molding of the key body. Therefore, it is possible to effectively suppress generation of sink marks on the top portion of the key body.

Preferably, the one or each of the engagement protrusions of the weight is formed to have a vertical length dimension smaller than a vertical length dimension of the one or each of the plurality of grooves.

With the construction of this preferred embodiment, since the vertical length dimension of the one or each of the grooves formed in the inner surfaces of the side portions of the key body is larger than the vertical length dimension of the one or each of the engagement protrusions formed on the weight, when the weight is bonded to the inside of the key body using an adhesive, the adhesive is collected in gaps formed in the grooves engaged with the engagement protrusions, whereby it is possible to more firmly bond the weight to the inside of the key body. Further, the gaps function as spaces for receiving extra adhesive.

The above and other objects, features, and advantages of the present invention will become more apparent from the following detailed description taken in conjunction with the accompanying drawings.

### BRIEF DESCRIPTION OF THE DRAWINGS

FIGS. 1A and 1B are perspective views of a part (one octave section) of a keyboard device for an electronic piano to which the present invention is applied, in which FIG. 1A shows the appearance of the keyboard device and FIG. 1B shows a state in which keys other than a white key and a black key at a left end of the keyboard device are omitted;

FIG. 2 is a perspective view of the keyboard device shown in FIG. 1B in a state in which the white key and the black key are removed, together with respective key support mechanisms therefor, from a keyboard chassis;

FIG. 3A is a plan view of the keyboard device shown in FIG. 1B and FIG. 3B is a cross-sectional view taken along line A-A of FIG. 3A;

FIGS. 4A and 4B are perspective views of the white key and the key support mechanism therefor, in which FIG. 4A shows the white key and the key support mechanism in a connected state and FIG. 4B shows the white key and the key support mechanism in an exploded state;

FIGS. 5A and 5B are perspective views of the black key and the key support mechanism therefor, in which FIG. 5A shows the black key and the key support mechanism in a connected state and FIG. 5B shows the black key and the key support mechanism in an exploded state;

FIGS. 6A and 6B are views useful in explaining operation of the white key in the keyboard device, in which FIG. 6A shows a key-released state and FIG. 6B shows a key-depressed state;

FIG. 7A and 7B are views useful in explaining operation of the black key in the keyboard device, in which FIG. 7A shows a key-released state and FIG. 7B shows a key-depressed state;

FIGS. 8A to 8C are views useful in explaining an essential part of a first embodiment of the present invention, in which FIG. 8A is a cross-sectional view similar to FIG. 3B, FIG. 8B is a view showing a rear portion of a first arm and components therearound on an enlarged scale, and FIG. 8C is a view showing only the rear portion of the first arm on an enlarged scale;

FIGS. 9A to 9D are views showing a sequence of states in which a plurality of protrusions formed on the rear portion of the first arm move into contact with cushions;

FIG. 10A is a side view of a key body of the white key in a second embodiment of the present invention, and FIG. 10B is a bottom view of the key body;

FIG. 11A is a cross-sectional view taken along line B-B of FIG. 10A, and FIG. 11B is a cross-sectional view of a white key according to a variation of the present embodiment;

FIG. 12A is a perspective view of a weight, and FIG. 12B is a perspective view of a weight according to a variation of the present embodiment; and

FIG. 13A is a cross-sectional view of the key body in a state in which the weight is accommodated in the key body, and FIG. 13B is a perspective view of the key body in a state in which a weight according to another variation is accommodated in the key body.

### DETAILED DESCRIPTION OF PREFERRED EMBODIMENTS

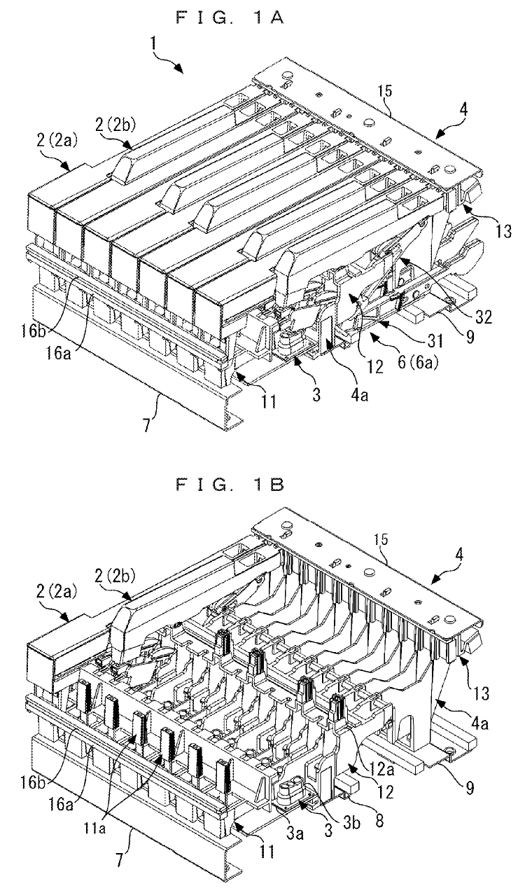

The present invention will now be described in detail with reference to the drawings showing preferred embodiments thereof. FIG. 1A shows only one octave section of a keyboard device 1 for an electronic piano to which the present invention is applied. Note that in the following, a description will be first given of the basic construction of the keyboard device 1 and operation thereof, and then of essential parts of the present invention.

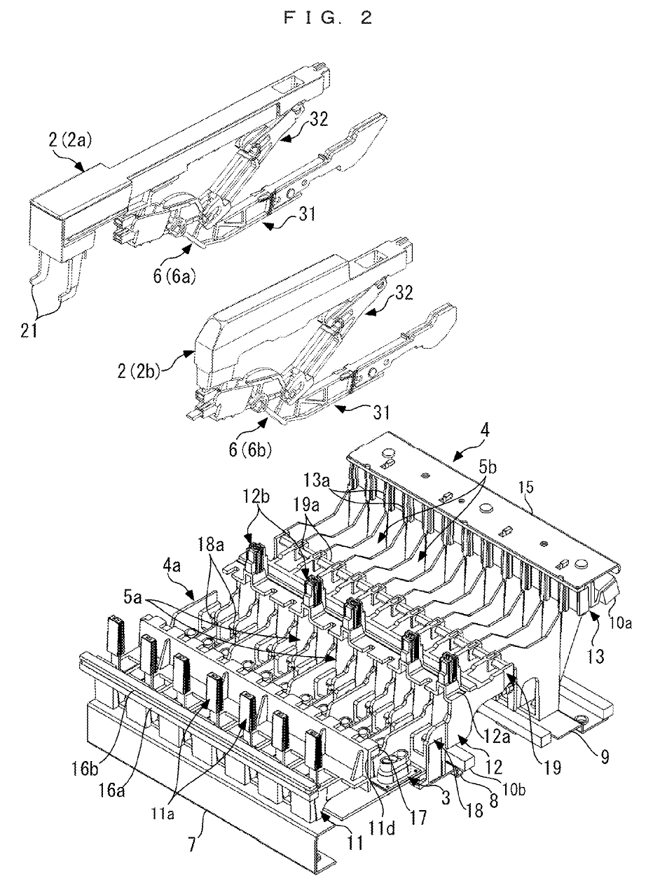

FIG. 1B shows a state of the keyboard device 1 shown in FIG. 1A, in which keys 2 other than a white key 2a and a black key 2b at the left end of the keyboard device 1 are omitted. FIG. 2 shows a state of the keyboard device 1 shown in FIG. 1B, in which the white key 2a and the black key 2b are removed, together with respective key support mechanisms 6 therefor, from a keyboard chassis 4.

This keyboard device 1 is comprised of the keyboard chassis 4, the plurality of keys 2 including the white keys 2a and the black keys 2b and arranged side by side in a left-right direction, the plurality of key support mechanisms 6 each pivotally mounted on the keyboard chassis 4, for supporting an associated one of the keys 2 from below, and key switches 3 each for detecting key depression information of an associated one of the keys 2.

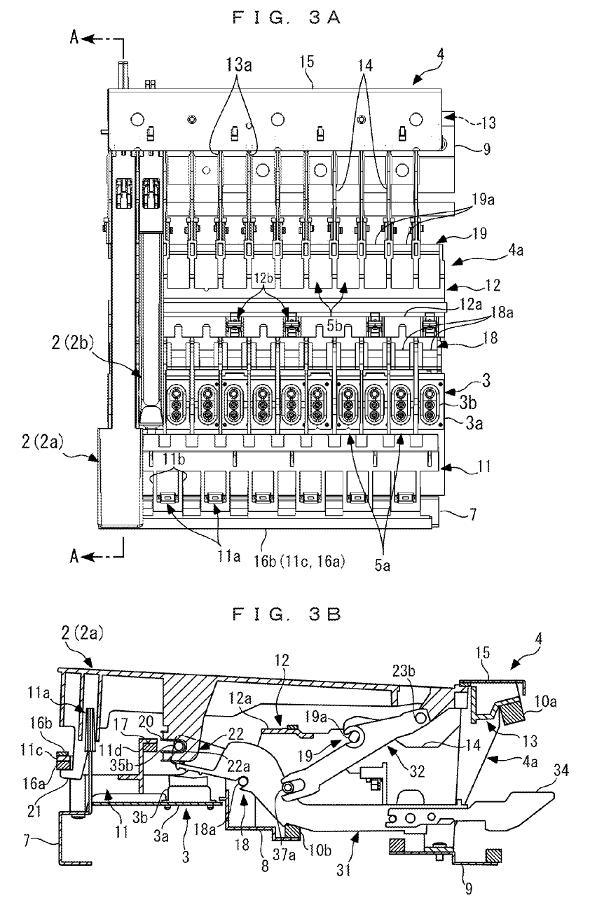

The keyboard chassis 4 includes a chassis body 4a formed as a resin molded article which is made e.g. by injection molding of a predetermined resin material (e.g. an ABS resin) into a predetermined shape. As shown in FIGS. 3A and 3B, the chassis body 4a has a front portion 11, an intermediate portion 12, and a rear portion 13, each extending in the left-right direction (in a left-right direction as viewed in FIG. 3A) as a whole. The front portion 11, the intermediate portion 12, and the rear portion 13 are integrally formed with each other via a plurality of ribs 14 disposed with a spacing therebetween in the left-right direction and each extending in the front-rear direction. Note that in the following description, the front portion 11, the intermediate portion 12, and the rear portion 13 of the chassis body 4a of the keyboard chassis 4 will be referred to as “the chassis front 11”, “the chassis intermediate 12”, and “the chassis rear 13”, respectively.

The chassis front 11 is mainly for guiding the white key 2a during depression thereof and restricting the upper limit position and the lower limit position of a front end of the white key 2a. On the chassis front 11, there are erected a plurality of white key guides 11a, each of which is inserted into each associated one of the white keys 2a from below so as to prevent lateral swing of the white key 2a, in a state arranged side by side in the left-right direction. Further, the chassis front 11 has engagement holes 11b and 11b, vertically extending therethrough, which are formed on the left and right sides of each of the white key guides 11a, respectively. A pair of left and right upper limit position regulation portions 21 and 21, referred to hereinafter, of the white key 2a are engaged with the respective engagement holes 11b and 11b in a state inserted therethrough. Furthermore, the chassis front 11 has a front end thereof formed with a stopper-mounting portion 11c that protrudes forward and extends along the entirety of the chassis body 4a in the left-right direction. A key upper limit stopper 16a and a key lower limit stopper 16b for the white key are mounted on a lower surface and an upper surface of the stopper-mounting portion 11c, respectively, such that they extend in the left-right direction. Note that a stopper-mounting portion 11d for the black key, which extends along the entirety of the chassis body 4a in the left-right direction, is provided at a predetermined location of the chassis front 11, rearward of each white key guide 11a, and a key upper limit stopper 17 for the black key is mounted on the stopper-mounting portion 11d such that it extends in the left-right direction.

The chassis intermediate 12 is mainly for guiding the black key 2b during depression thereof and swingably supporting a first arm 31 and a second arm 32, described hereinafter, of each of a white key-associated key support mechanism 6a and a black key-associated key support mechanism 6b. The chassis intermediate 12 has a flat portion 12a in the form of a flat plate extending in the left-right direction, and a plurality of black key guides 12b erected on the flat portion 12a and disposed with an appropriate spacing therebetween in the left-right direction. Each black key guide 12b is inserted into an associated one of the black keys 2b from below to prevent lateral swing of the black key 2b. Further, the chassis intermediate 12 has a front portion thereof provided with a first arm support portion 18 for supporting the first arms 31 of the key support mechanisms 6. The first arm support portion 18 has a plurality of first pivot shafts 18a each of which is provided between each adjacent two of the ribs 14 and 14 such that the first pivot shaft 18a extends in the left-right direction. The first arms 31 are swingably supported on associated ones of the first pivot shafts 18a. Furthermore, the chassis intermediate 12 has a rear portion thereof provided with a second arm support portion 19 for supporting the second arms 32 of the key support mechanisms 6. The second arm support portion 19 has a plurality of second pivot shafts 19a each of which is provided between each adjacent two of the ribs 14 and 14 such that the second pivot shaft 19a extends in the left-right direction. The plurality of second pivot shafts 19a are arranged on the same axis extending in the left-right direction at a location rearward of and higher than the first pivot shafts 18a, and the second arms 32 are swingably supported on associated ones of the second pivot shafts 19a. Note that a first arm lower limit stopper 10b extending along the entirety of the chassis body 4a in the left-right direction is provided at a predetermined location of a middle rail 8, referred to hereinafter, disposed below the chassis intermediate 12.

Further, the above-mentioned key switches 3 are provided on a lower portion of the keyboard chassis 4 between the above-described chassis front 11 and chassis intermediate 12. The key switches 3 are formed by a laterally elongated printed circuit board 3a extending in the left-right direction, and a plurality of switch bodies 3b formed by rubber switches attached to the printed circuit board 3a on a key-by-key basis, for being pressed by associated ones of the first arms 31 upon key depression.

The chassis rear 13 is mainly for guiding the keys 2 by their rear ends in the vertical direction while preventing lateral swing of the keys 2 and for restricting the upper limit positions of the rear ends of associated ones of the first arms 31. As shown in FIGS. 2 and 3A, the chassis rear 13 has a plurality of partition walls 13a formed with a predetermined spacing therebetween in the left-right direction so as to separate each adjacent two of the keys 2 and 2 from each other. Further, as shown in FIG. 3B, a first arm upper limit stopper 10a extending along the entirety of the chassis body 4a in the left-right direction is provided at a predetermined location of an upper portion of the chassis rear 13. The first arm upper limit stopper 10a and the first arm lower limit stopper 10b provided on the chassis intermediate 12 are for restricting the upper limit position and the lower limit position of the first arm 31, respectively, when the first arm 31 having a function as a hammer for adding a touch weight to the key 2 pivotally moves upward and downward. Furthermore, a metal cover plate 15 extending in the left-right direction along the entirety of the chassis body 4a and disposed to cover the rear ends of the keys 2 is mounted on the upper portion of the chassis rear 13.

As shown in FIGS. 2 and 3A, the chassis body 4a of the keyboard chassis 4 constructed as described above is formed with a plurality of first openings 5a open upward and forward and a plurality of second openings 5b open upward. The first arms 31 of the key support mechanisms 6 are engaged with associated ones of the first pivot shafts 18a from outside via the above-mentioned first openings 5a, respectively. Further, the second arms 32 are engaged with associated ones of the second pivot shafts 19a from outside via the above-mentioned second openings 5b, respectively.

Further, in the above-described keyboard chassis 4, a plurality of chassis bodies 4a are connected to each other so as to be arranged side by side in the left-right direction, and are each screwed to a front rail 7, the middle rail 8, and a rear rail 9 in a state placed thereon, the rails 7, 8 and 9 each extending in the left-right direction and arranged with a predetermined spacing therebetween in the front-rear direction. The keyboard chassis 4 is fixed to a keybed, not shown, of the electronic piano via the front rail 7 and the rear rail 9.

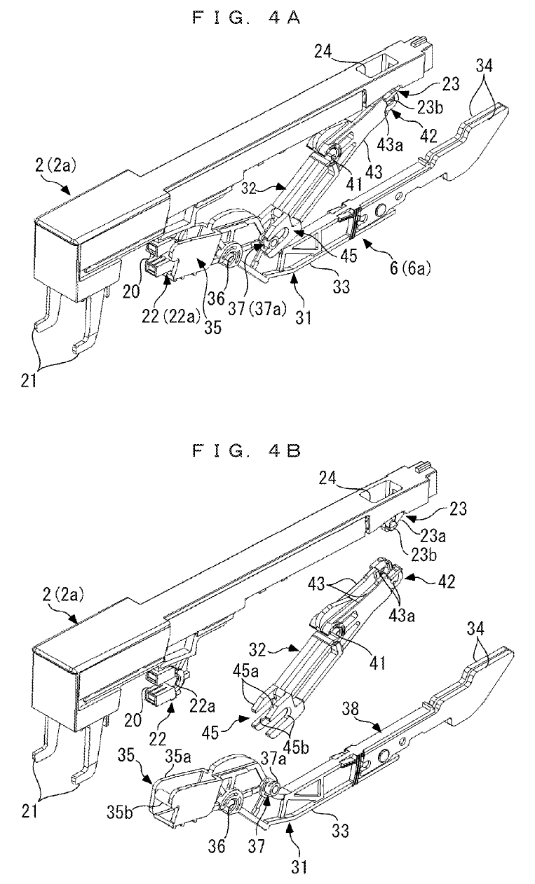

Next, the keys 2 and the key support mechanisms 6 will be described. FIG. 4A shows the white key 2a and the key support mechanism 6a therefor on an enlarged scale, and FIG. 4B shows them in an exploded state. As shown in FIGS. 4A and 4B, the white key 2a is formed e.g. by injection molding of a predetermined resin material (e.g. an AS resin) into a hollow shape which extends a predetermined length in the front-rear direction and opens downward. The white key 2a has the front end thereof formed with the pair of left and right upper limit position regulation portions 21 and 21 which protrude downward from respective side walls of the front end of the white key 2a and each having a lower end thereof bent forward. As described hereinabove, the left and right upper limit position regulation portions 21 and 21 are engaged with the respective left and right engagement holes 11b and 11b of the chassis front 11 in a state inserted therethrough.

Further, at a predetermined location of a front portion of the white key 2a, rearward of the upper limit position regulation portions 21, there is formed a key front-side connecting portion 22 connected to the first arm 31 of the key support mechanism 6a. This key front-side connecting portion 22 includes a connecting recess (engagement recess) 22a which has a U shape having a slot-like shape in side view and open forward. Further, the connecting recess 22a has a key-side noise suppressing member 20 attached thereto, which is formed to cover the whole inner peripheral surface of the connecting recess 22a, for suppressing generation of noise when a connecting shaft 35b, referred to hereinafter, of the first arm 31 slides in the inner peripheral surface of the connecting recess 22a.

Furthermore, the white key 2a has a rear portion thereof provided with a key rear-side connecting portion 23 connected to the second arm 32 of the key support mechanism 6a. The key rear-side connecting portion 23 has a plate-like connecting body portion 23a which hangs downward from a laterally central portion of the white key 2a and has a predetermined thickness in the left-right direction, and a pair of left and right engagement protrusions 23b and 23b which coaxially protrude from the left and right side surfaces of the connecting body portion 23a, respectively. Further, a rear portion of the white key 2a is formed with a tool insertion hole 24 which vertically extends through the rear portion, and is used to insert a predetermined tool from above for disconnecting the white key 2a from the second arm 32 of the key support mechanism 6a e.g. for maintenance of the keyboard device 1.

On the other hand, the key support mechanism 6a includes the first arm 31 and the second arm 32 which are engaged with each other and are connected to the key front-side connecting portion 22 and the key rear-side connecting portion 23 of the white key 2a, respectively.

As shown in FIG. 4B, the first arm 31 is comprised of an arm body 33 and two weights 34 and 34 attached to the arm body 33. The arm body 33 is formed as a resin molded article which is made e.g. by injection molding of a predetermined resin material (e.g. polyacetal resin) into a predetermined shape. This arm body 33 extends a predetermined length in the front-rear direction, and has a front end thereof formed with a first arm front-side connecting portion 35 connected to the key front-side connecting portion 22 of the white key 2a. The first arm front-side connecting portion 35 includes a box portion 35a having a box-like shape open upward and forward, and the connecting shaft 35b provided such that it extends in the left-right direction in a state connecting the front-side upper ends of left and right side walls of the box portion 35a to each other. The connecting shaft 35b is connected to the connecting recess 22a of the key front-side connecting portion 22 of the white key 2a such that the connecting shaft 35b is pivotally movable and is slidable in the front-rear direction.

Further, the arm body 33 has a bearing portion 36 formed at a predetermined location immediately rearward of the first arm front-side connecting portion 35. The bearing portion 36 has an inverted U shape open downward in side view, and is pivotally engaged with the first pivot shaft 18a of the keyboard chassis 4. Furthermore, the arm body 33 has a first arm rear-side connecting portion 37, which is connected to the second arm 32, at a predetermined location rearward of the bearing portion 36. Specifically, the first arm rear-side connecting portion 37 has a connecting shaft 37a which extends in the left-right direction with respective opposite ends thereof protruding outward from the left and right side surfaces of the arm body 33. The opposite ends of the connecting shaft 37a are engaged with connecting recesses 45b and 45b of a second arm front-side connecting portion 45, referred to hereinafter, of the second arm 32.

The two weights 34 and 34 formed as elongated and narrow plates are mounted on a weight mounting portion 38, which is a rear portion of the arm body 33, in a state sandwiching the weight mounting portion 38. Note that each weight 34 is made of a material (metal such as iron) having a larger specific gravity than the arm body 33, and is formed e.g. by pressing a metal plate into a predetermined shape.

The second arm 32 is formed as a resin molded article having a predetermined shape by injection molding of the same resin material as that of the arm body 33 of the first arm 31. The second arm 32 is shorter than the first arm 31 and extends a predetermined length in the front-rear direction. Further, the second arm 32 has a bearing portion 41 having a C shape open forward in side view at about a longitudinal center thereof. The bearing portion 41 is pivotally engaged with an associated one of the second pivot shafts 19a of the keyboard chassis 4.

Further, the second arm 32 has a rear portion thereof provided with a second arm rear-side connecting portion 42 connected to the key rear-side connecting portion 23 of the white key 2a. The second arm rear-side connecting portion 42 is formed into a bifurcated shape, and has two left and right connecting arm portions 43 and 43 which extend a predetermined length parallel to each other along the longitudinal direction of the second arm 32. Each connecting arm portion 43 has a rear end thereof formed with a connecting hole 43a extending through the connecting arm portion 43 in the left-right direction. The two connecting arm portions 43 and 43 sandwich the connecting body portion 23a of the key rear-side connecting portion 23 of the white key 2a between the rear ends thereof from the left and the right, and each connecting hole 43a has an associated one of the engagement protrusions 23b of the key rear-side connecting portion 23 pivotally fitted therein.

Furthermore, the second arm 32 has a front portion thereof provided with the second arm front-side connecting portion 45 connected to the first arm rear-side connecting portion 37 of the first arm 31. The second arm front-side connecting portion 45 has a pair of left and right connecting portions 45a and 45a arranged with a predetermined spacing in the left-right direction. The connecting portions 45a and 45a are each formed with the connecting recess 45b which has a U shape having a slot-like shape in side view and open forward. The left and right connecting portions 45a and 45a of the second arm front-side connecting portion 45 are pivotally and slidably engaged with the respective opposite ends of the connecting shaft 37a of the first arm 31 via the connecting recesses 45b and 45b thereof.

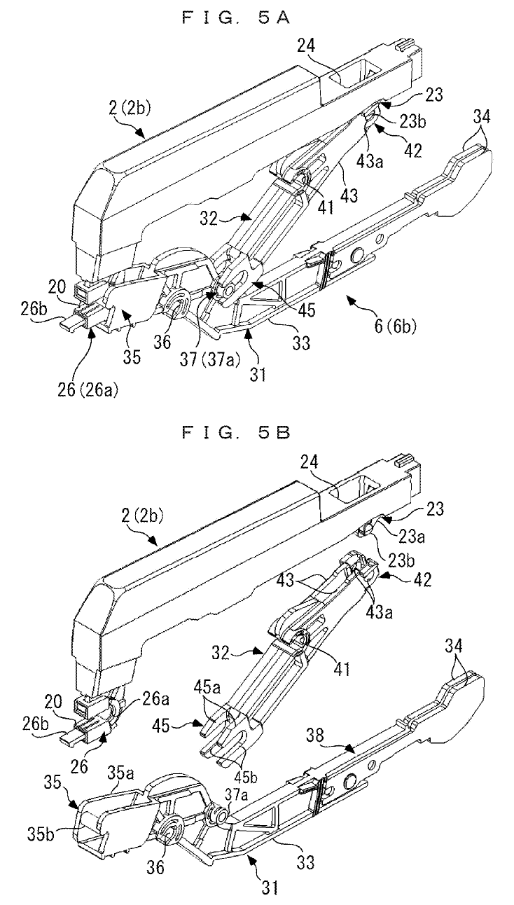

FIG. 5A shows the black key 2b and the key support mechanism 6b therefor on an enlarged scale, and FIG. 5B shows the black key 2b and the key support mechanism 6b in an exploded state. The black key 2b is formed e.g. by injection molding of the same resin material as that of the white key 2a into a hollow shape which extends in the front-rear direction by a predetermined length shorter than that of the white key 2a and opens downward. The black key 2b has a front-side lower end thereof provided with a key front-side connecting portion 26 formed substantially similar to the key front-side connecting portion 22 of the white key 2a. This key front-side connecting portion 26 has a connecting recess 26a which has a U shape having a slot-like shape in side view and open forward. Further, the key front-side connecting portion 26 has an extension portion 26b on a lower-side front end of the connecting recess 26a. The extension portion 26b extends a predetermined length forward of the front surface of the body of the black key 2b. This extension portion 26b functions as an upper limit position regulation portion of the black key 2b. Note that in the following description, the components of the black key 2b and the key support mechanism 6b having the same configurations as those of the above-described white key 2a and key support mechanism 6a are denoted by the same reference numerals and detailed description thereof will be omitted.

The key support mechanism 6b supporting the black key 2b is constructed substantially similar to the above-described white key-associated key support mechanism 6a. Specifically, the arm body 33 of the first arm 31 of the key support mechanism 6b and the second arm 32 of the same are constructed exactly similar in shape and size to the arm body 33 and the second arm 32 of the white key-associated key support mechanism 6a. Note that two left and right weights 34 and 34 of the black key-associated key support mechanism 6b differ from the weights 34 of the white key-associated key support mechanism 6a in the shape of the rear portion thereof.

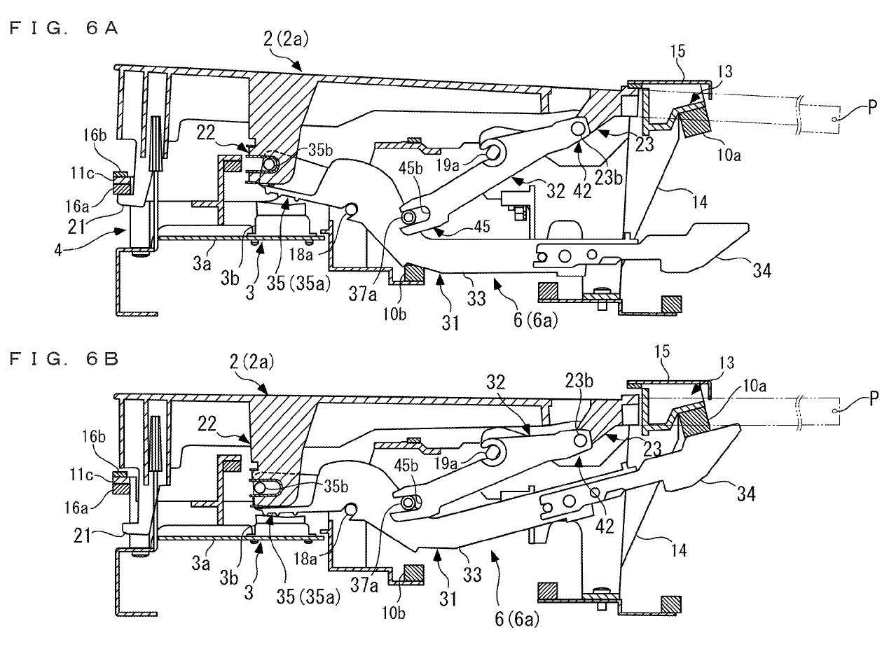

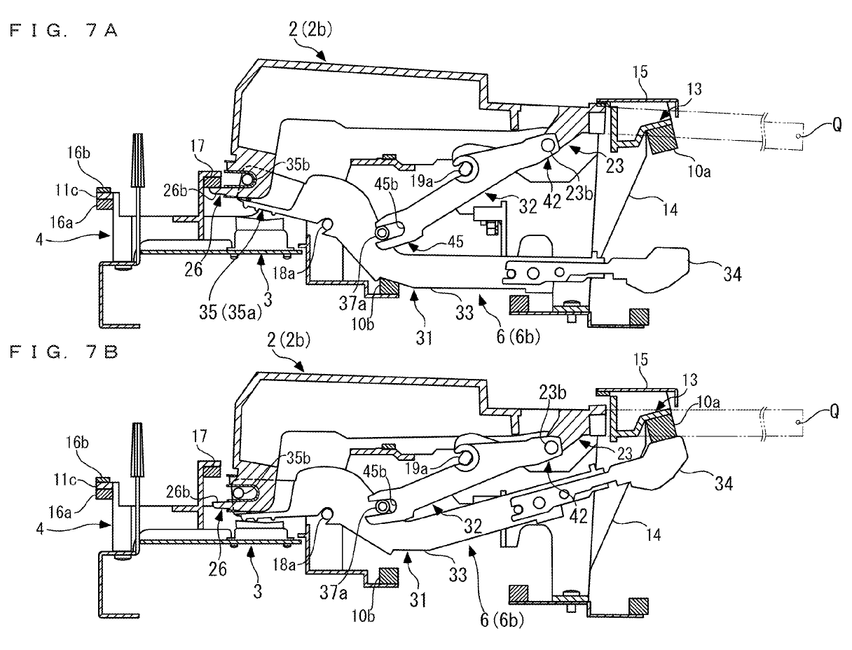

Next, a description will be given of the operation of the keys 2 and the key support mechanisms 6 of the keyboard device 1 constructed as described above. FIGS. 6A and 6B are views useful in explaining the operation of the white key 2a and the key support mechanism 6a associated therewith. FIGS. 7A and 7B are views useful in explaining the operation of the black key 2b and the key support mechanism 6b associated therewith.

When the front end of the white key 2a is depressed by a player with his/her finger from a key-released state shown in FIG. 6A, the key front-side connecting portion 22 of the white key 2a is moved downward, whereby the first arm 31 is pivotally moved in a counterclockwise direction about the first pivot shaft 18a. Further, in accordance with the pivotal movement of the first arm 31, the second arm front-side connecting portion 45, which is engaged with the connecting shaft 37a of the first arm 31 via the connecting recesses 45b and 45b, is moved upward. With this, the second arm 32 is pivotally moved in a clockwise direction about the second pivot shaft 19a. Then, in accordance with this pivotal movement of the second arm 32, the key rear-side connecting portion 23, which is connected to the second arm 32 via the second arm rear-side connecting portion 42 formed at the rear end of the second arm 32, is pulled down, whereby the rear end of the white key 2a is moved downward.

Note that during the above-mentioned pivotal movement of the first arm 31, the box portion 35a of the first arm front-side connecting portion 35 is moved downward, and accordingly, the switch body 3b of one of the key switches 3, which is associated with the depressed key 2, is pressed from above by the bottom wall of the box portion 35a. As a consequence, in the electronic piano, key depression information of the depressed key 2 is detected, and based on the detected key depression information, sound is generated from a speaker, not shown.

As described hereinabove, in the case where the white key 2a is depressed, in accordance with the counterclockwise pivotal movement of the first arm 31, the weight 34 of the first arm 31 is tilted such that the weight 34 becomes higher as it extends rearward, whereby the rear end of the weight 34 is brought into contact with the first arm upper limit stopper 10a from below, as shown in FIG. 6B. This prevents further pivotal movement of the first arm 31. When the front end of the white key 2a is depressed to its lowest position, the front end of the white key 2a is brought into contact with the key lower limit stopper 16b, which blocks further depression of the white key 2a.

The white key 2a depressed as above operates such that it pivotally moves about a virtual pivot P located rearward of the rear end thereof. The location of the virtual pivot P is set such that a distance from the front end of the white key 2a is approximately twice as long as the length of the white key 2a itself, for example. With this, when the front end of the white key 2a is depressed to the lowest position, compared with the case where the white key 2a is in the key-released state shown in FIG. 6A, the front end of the white key 2a is positioned lower by a predetermined key stroke (e.g. 10 mm) and the rear end of the white key 2a is positioned lower by a distance (e.g. 5 mm) which is approximately half of the predetermined key stroke.

On the other hand, when the finger is released from the white key 2a being depressed, the first arm 31 of the key support mechanism 6a pivotally moves in a direction opposite to the above-mentioned direction, by the own weight of the weight 34, and in accordance therewith, the second arm 32 as well pivotally moves in a direction opposite to the above-mentioned direction. In accordance with this pivotal movement of the second arm 32, the white key 2a pivotally moves upward about the virtual pivot P. Then, a predetermined portion of the first arm 31, rearward of the first pivot shaft 18a, moves into contact with the first arm lower limit stopper 10b from above, and both of the upper limit position regulation portions 21 and 21 of the white key 2a move into contact with the key upper limit stopper 16a from below, whereby further pivotal movement of the white key 2a is blocked and the white key 2a returns to its original key-released state.

Further, operation in response to depression of the black key 2b is performed similar to the above-described operations of the white key 2a and the key support mechanism 6a in response to depression of the white key 2a. More specifically, when a front end of the black key 2b is depressed from a key-released state shown in FIG. 7A, the first arm 31 is pivotally moved in the counterclockwise direction about the first pivot shaft 18a, and the second arm 32 is pivotally moved in the clockwise direction about the second pivot shaft 19a. With this, the black key 2b operates such that it pivotally moves about a virtual pivot Q located rearward of the rear end thereof. Note that similar to the above-mentioned virtual pivot P of the white key 2a, the location of the virtual pivot Q is set such that a distance from the front end of the black key 2b is approximately twice as long as the length of the black key 2b itself, for example. Therefore, when the front end of the black key 2b is depressed to its lowest position, compared with a case where the black key 2b is in the key-released state shown in FIG. 7A, the front end of the black key 2b is positioned lower by a predetermined key stroke and the rear end thereof is positioned lower by a distance which is approximately half of the predetermined key stroke.

On the other hand, when the finger is released from the black key 2b having been depressed, the first arm 31 and the second arm 32 of the key support mechanism 6b pivotally move in respective directions opposite to the above-mentioned directions, and in accordance therewith, the black key 2b pivotally moves upward about the virtual pivot Q. Then, the extension portion 26b of the key front-side connecting portion 26 of the black key 2b moves into contact with the key upper limit stopper 17 from below, whereby further pivotal movement of the black key 2b is blocked, and the black key 2b returns to its original key-released state.

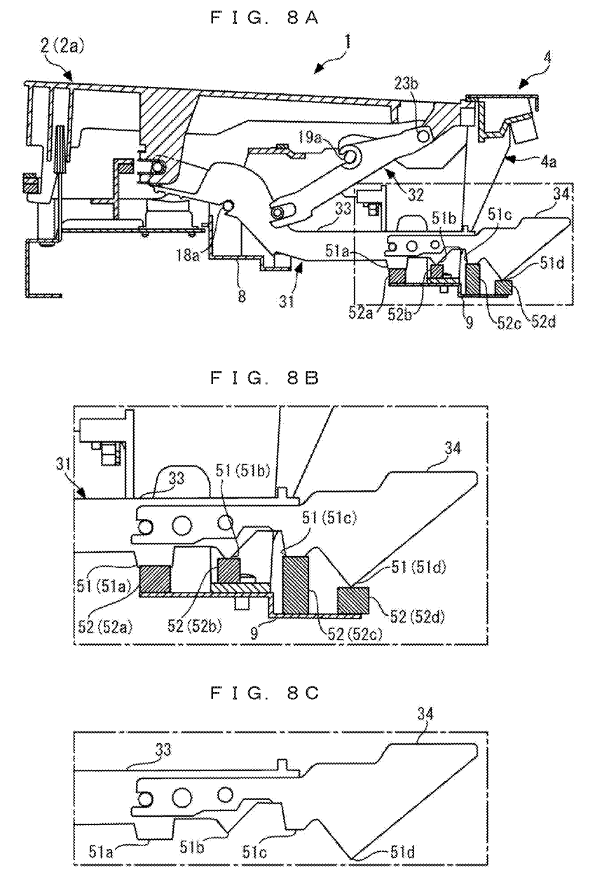

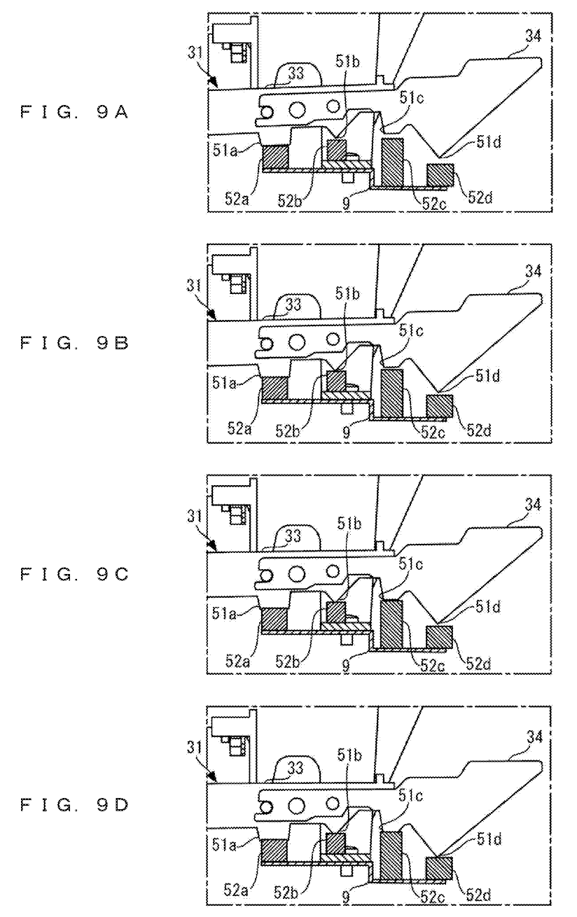

Next, an essential part of a first embodiment of the present invention will be described with reference to FIGS. 8A to 9D. The essential part of the first embodiment of the present invention is that the first arm 31 (hammer) provided for each associated one of the keys 2 has a rear portion thereof formed with a plurality of protrusions 51, and there are provided a plurality of cushions 52 which are contacted by the protrusions 51 from above, respectively.

As shown in FIGS. 8A and 8B, in the keyboard device 1 of the present invention, along the rear portion (right portion as viewed in FIG. 8A) of the first arm 31 provided for each associated one of the keys 2, four protrusions 51 are formed at respective spaced locations in a sequence in the front-rear direction. Further, four cushions 52, which are fixed to the rear rail 9, are provided below the four protrusions 51, respectively.

Note that in the following description, the above-mentioned four protrusions 51 will be referred to as “the first protrusion 51a”, “the second protrusion 51b”, “the third protrusion 51c”, and “the fourth protrusion 51d”, in order from a front side (left side as viewed in FIG. 8) closest to the first pivot shaft 18a (hammer support shaft). Further, the four cushions 52 will be referred to as “the first cushion 52a”, “the second cushion 52b”, “the third cushion 52c”, and “the fourth cushion 52d”, in order from the front side.

As shown in FIG. 8C, the first protrusion 51a and the second protrusion 51b protrude downward by respective predetermined lengths, and are integrally formed with the arm body (hammer body) 33. Further, the first protrusion 51a has a bottom surface formed flat, whereas the second protrusion 51b is formed into a shape tapered downward.

Further, the third protrusion 51c and the fourth protrusion 51d protrude downward by respective predetermined lengths, and are integrally formed with the weights 34. Further, the third protrusion 51c has a bottom surface formed flat, whereas the fourth protrusion 51d is formed into a shape tapered downward.

On the other hand, the four cushions 52 are each formed of an elastic material, such as urethane, and extend a predetermined length along the rear rail 9 in the left-right direction (in a depth direction as viewed in FIG. 8). The four cushions 52 each have a predetermined rectangular shape in transverse cross-section over the entire longitudinal length thereof, and have a horizontally extending upper surface.

Further, each of the four cushions 52 is configured to have lower resilience as it is closer to the first pivot shaft 18a. That is, out of the four cushions 52, the first cushion 52a has the lowest resilience, and the fourth cushion 52d has the highest resilience.

FIGS. 9A to 9D show a sequence of states in which the four protrusions 51 move into contact with associated ones of the cushions 52 when the first arm 31 having been pivotally moved upward in accordance with depression of the key 2 returns to its original position in accordance with release of the key 2. More specifically, as shown in FIG. 9A, first, the first protrusion 51a of the first arm 31 contacts the first cushion 52a, and then, as shown in FIG. 9B, the second protrusion 51b contacts the second cushion 52b. Then, as shown in FIG. 9C, the third protrusion 51c contacts the third cushion 52c, and finally, as shown in FIG. 9D, the fourth protrusion 51d contacts the fourth cushion 52d. As described above, when the first arm 31 including the above-described four protrusions 51 contacts the four cushions 52 from above, the four protrusions 51 contact respective associated ones of the cushions 52 in order from the protrusion 51 closest to the first pivot shaft 18a.

In the keyboard device 1 which includes the first arm 31 including the four protrusions 51 constructed as described above, and the four cushions 52, when the four protrusions 51 of the first arm 31 move into contact with the four cushions 52, respectively, kinetic energy of the first arm 31 being pivotally moved is progressively reduced by the four cushions 52, whereby it is possible to prevent the first arm 31 from bouncing when all the protrusions 51 of the first arm 31 contact the cushions 52. As a consequence, it is possible to suppress occurrence of bouncing of the key 2, which causes vertical vibration of an upper surface of the key 2 that moves in accordance with pivotal movement of the first arm 31. Further, when the first arm 31 contacts the cushions 52, the first arm 31 sequentially contacts the four cushions 52a to 52d in the mentioned order, whereby it is possible to progressively reduce the speed and momentum of the first arm 31 being pivotally moved, so that compared with the conventional keyboard device in which a hammer contacts a single stopper, it is possible to suppress generation of noise.

Further, since the second protrusion 51b and the fourth protrusion 51d of the four protrusions 51 of the first arm 31 are each formed into a shape tapered downward, these two protrusion 51b and 51d contact the respective cushions 52b and 52d associated therewith such that contact areas therebetween are progressively increased. With this, compared with a case where contact areas formed when the first arm 31 contacts the cushions 52 are large from the beginning, it is possible to suppress generation of noise when the first arm 31 contacts the cushions 52.

Furthermore, since each of the four cushions 52 is configured to have lower resilience as it is closer to the first pivot shaft 18a, it is possible to progressively reduce the kinetic energy of the first arm 31 being pivotally moved, while effectively suppressing generation of noise when the respective protrusions 51 of the first arm 31 contact the cushions 52. This makes it possible to effectively suppress generation of noise and occurrence of bouncing of the key 2 when the first arm 31 contacts the cushions 52.

Note that the present invention is not limited to the above-described embodiment, but it can be practiced in various forms. For example, although in the present embodiment, the four protrusions 51 are provided on the first arm 31, and the four cushions 52 are provided in association with the protrusions 51, the present invention is not limited to this, but it is also possible to provide two or three, or five or more protrusions 51 on the first arm 31. In these cases, a corresponding number of cushions 52 to the number of the protrusions 51 are provided.

Further, although in the above-described embodiment, the description is given of a case where the present invention is applied to the keyboard device 1 in which the keys 2 depressed operate such that they pivotally move about the virtual pivots P and Q located rearward of the rear ends of the keys 2, respectively, the present invention is not limited to this, but as a matter of course, the present invention can be applied to a general keyboard device in which keys are pivotally moved about the rear ends of their own, respectively, and each of which is not provided with the second arm 32. Further, details of the constructions of the first arm 31, the protrusions 51, and the cushions 52 shown in the embodiment are given only by way of example, and they can be modified as appropriate within the scope of the subject matter of the present invention.

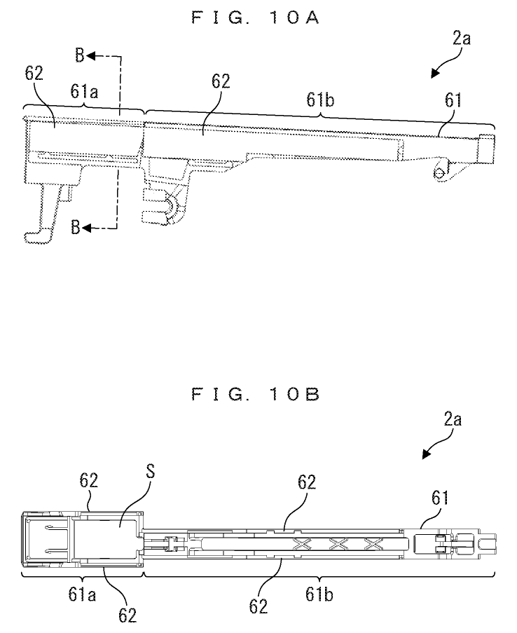

Next, an essential part of a second embodiment of the present invention will be described with reference to FIGS. 10A to 13B. The essential part of the second embodiment of the present invention is a weight attachment structure in which a weight is attached to the inside of a key body. Although in the present embodiment, a description will be given of an example in which the weight attachment structure is applied to a white key, the same attachment structure may be applied to a black key.

FIG. 10A is a side view of the key body of the white key, as viewed from one side thereof, and FIG. 10B is a view of the same key body, as viewed from below. As described hereinabove, the key body, denoted by reference numeral 61, of the white key 2a is formed by injection molding of a predetermined resin material (e.g. an AS resin). The white key 2a of the present embodiment is e.g. an A key (key for the tone of la), and the key body 61 of the white key 2a is comprised of a large width portion 61a adjacent to another white key 2a, and a small width portion 61b adjacent to one of the black keys 2b. Woody boards, denoted by reference numeral 62, for imparting a woody feeling to the key are attached to the left and right side portions of the large width portion 61a and the small width portion 61b. Woody materials, including not only wood materials but also wood-grain decorative boards, plywood boards, medium density fiberboards (MDF), and so forth, can be used for the woody boards 62. In the present embodiment, a soft wood material with a specific gravity of 0.5 or less is used for the woody boards 62. Examples of such wood materials include spruce and predetermined tropical wood.

As shown in FIG. 10B, the key body 61 is formed into a hollow shape open downward, and the large width portion 61a is provided with an inner space S for accommodating a weight 64, 64a, or 64b, described hereinafter.

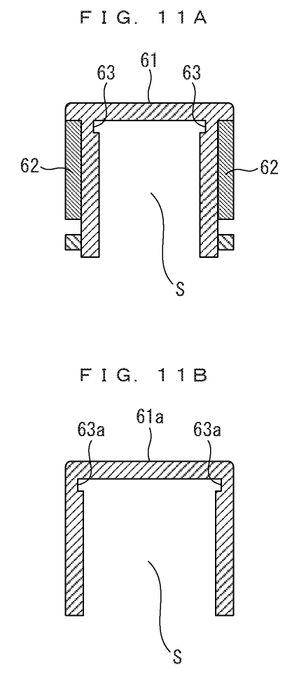

FIG. 11A is a cross-sectional view taken along line B-B of FIG. 10A. As shown in FIG. 11A, the key body 61 has grooves 63 formed in the inner surfaces of a pair of left and right side portions of the key body 61. The grooves 63 are formed in the uppermost portions of the inner surfaces of the side portions of the large width portion 61a and the small width portion 61b such that the grooves 63 extend long along the front-rear direction. Further, the top portion of the key body 61 has left and right ends thereof protruding laterally from the pair of the respective side portions of the large width portion 61a and the small width portion 61b, and covers the upper end surfaces of the woody boards 62 attached to the side portions. With this construction, the appearance of the key as viewed laterally is made similar to that of a wooden key.

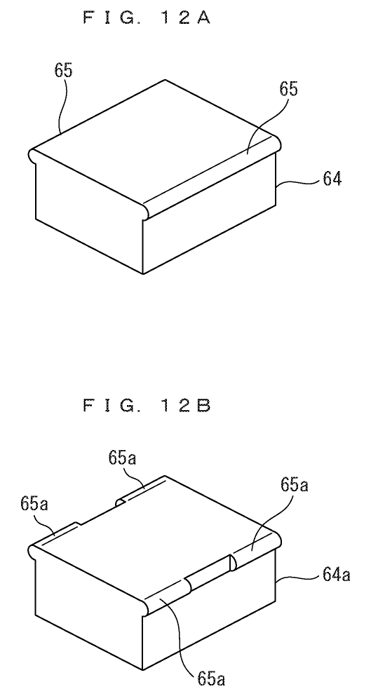

FIG. 12A shows the weight 64 of the present embodiment. The weight 64 is accommodated in the key body 61 of each key of the keyboard device, for adjusting a weight balance of the key, thereby adjusting touch feeling of the key. The weight 64 of the present embodiment is made of an elastically deformable material and formed into a substantially a rectangular parallelepiped shape. The weight 64 can be made of an elastic material, such as synthetic rubber or thermoplastic elastomer. In the present embodiment, the weight 64 is made of e.g. chloroprene rubber. The weight 64 has an engagement protrusion 65 formed along an upper end of each of a pair of opposite side surfaces. When the weight 64 is accommodated in the inner space S of the key body 61, the engagement protrusion 65 is engaged with an associated one of the grooves 63 of the key body 61, thereby holding the weight 64 in the inner space S.

A length dimension between the above-mentioned pair of the side surfaces of the weight 64 is set to be approximately equal to a length dimension between the inner surfaces of the pair of the side portions of the key body 61. Further, a length dimension between the engagement protrusions 65 formed on the pair of the side surfaces of the weight 64 is set to be larger than the length dimension between the inner surfaces of the pair of the side portions of the key body 61, and to be approximately equal to a length dimension between the inner surfaces at locations where the grooves 63 are formed.

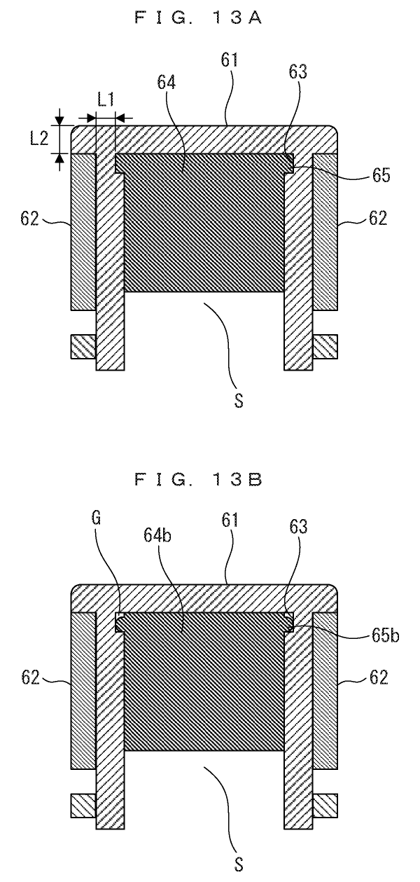

FIG. 13A shows the key body 61 in a state in which the weight 64 is accommodated in a predetermined position of the inner space S of the key body 61. The weight 64 is mounted in the predetermined position of the inner space S by being pushed into the inner space S from below the key body 51 open downward. When the weight 64 is pushed into the key body 61 from below, although the engagement protrusions 65 hit the pair of the side portions of the key body 61 first, the weight 64 is elastically deformed such that the engagement protrusions 65 are bent in a direction opposite to a push-in direction of the weight 64, whereby the weight 64 is inserted into the inner space S.

Then, when the weight 64 is further pushed upward and reaches the predetermined position of the inner space S, the engagement protrusions 65 having been elastically deformed return to their original shape in the grooves 63, whereby the engagement protrusions 65 are fitted in the grooves 63 for engagement therewith. Thus, when the weight 64 is accommodated in the predetermined position of the inner space S, it is possible to firmly hold the weight 64 in the key body 61 by the engagement between the engagement protrusions 65 and the grooves 63.

Note that the weight 64 may be more firmly bonded to the inside of the key body 61 by applying an adhesive or a double-faced tape to e.g. an upper surface of the weight 64.

As described hereinabove, in the key body 61 of the present embodiment, it is possible to firmly hold the weight 64 by using only the grooves 63 formed in the inner surfaces of the side portions, so that it is unnecessary to form additional protruding portions for preventing the weight from falling off. With this, a mold for molding the key body 61 can be simplified, so that it is possible to suppress increase in manufacturing costs.

Note that in the key body 61 as a molded article of a resin material, it is necessary to pay attention to generation of sink marks on portions which are thicker than the other portions, such as portions of the top portion, which are continuous with the side portions of the key body 61. Particularly, the top portion of the key body 61 provides a surface hit by a finger of a player at the time of key depression during musical performance of the player, and hence to prevent degradation of the appearance and the touch feeling of the white key 2a, it is important to effectively suppress generation of sink marks on the top portion of the key body 61. In the key body 61 of the present embodiment, the grooves 63 are formed in the uppermost portions of the inner surfaces of the pair of the side portions, so that a thickness dimension L1 of the uppermost portions of the side portions is smaller than a thickness dimension L2 of the top portion of the key body. In other words, in the key body 61 of the present embodiment, the grooves 63 formed in the uppermost portions of the side portions have effects of downgaging, which reduces a difference in the thickness of the portions of the top portion, which are continuous with the side portions, and the other portions of the top portion. With this, a cooling rate difference between the portions of the top portion continuous with the side portions and the other portions of the top portion becomes difficult to be caused during molding of the key body 61, whereby it is possible to effectively suppress generation of sink marks on the top portion of the key body 61.

FIG. 12B is a perspective view of a weight 64a according to a variation of the present embodiment. The weight 64a according to the variation is different from the above-described weight 64 in that, although in the weight 64, each of the pair of opposite side surfaces has one engagement protrusion 65 formed to extend along the entire area of the upper end thereof, in the weight 64a, each of a pair of opposite side surfaces has a plurality of engagement protrusions 65a formed along an upper end thereof. As described above, since the weight 64a has the plurality of engagement protrusions 65a formed to be shorter than the engagement protrusions 65, when the weight 64a is pushed into the inner space S of the key body 61, it is possible to deform the engagement protrusions 65a with a smaller force, whereby the weight 64a can be mounted easily. Further, when the engagement protrusions 65a are engaged with the grooves 63, a space is formed in each groove 63 at a location opposed to a non-contiguous portion between the engagement protrusions 65a, and hence e.g. when an adhesive is applied to an upper surface of the weight 64a, the adhesive is collected in the spaces, whereby it is possible to more firmly bond the weight 64a to the key body 61. Further, the space also functions to receive extra adhesive.

Further, FIG. 13B shows a state in which the weight 64b according to another variation of the present embodiment is accommodated in the predetermined position of the inner space S of the key body 61. This weight 64b is characterized in that engagement protrusions 65b thereof are formed to be smaller than the grooves 63. For example, the weight 64b is configured such that a vertical length dimension of the engagement protrusions 65b is smaller than a vertical length dimension of the grooves 63. With this, when the engagement protrusions 65b are engaged with the grooves 63, gaps G are formed between the engagement protrusions 65b and the grooves 63. Thus, when an adhesive is applied to an upper surface of the weight 64b, the adhesive is collected in the gaps G, whereby it is possible to more firmly bond the weight 64b to the key body 61. Further, the gaps G also functions as a space to receive extra adhesive.

As described hereinabove, according to the present embodiment, when the weight 64 is accommodated in the predetermined position of the inner space S of the key body 61, the engagement protrusions 65 of the weight 64 are fitted in the grooves 63 formed in the inner surfaces of the side portions, for engagement with the grooves 63, whereby it is possible to firmly hold the weight 64 in the key body 61. Further, since it is unnecessary to form additional protruding portions on the key body 61 for preventing the weight 64 from falling off, the mold for molding the key body 61 can be simplified, whereby it is possible to suppress increase in manufacturing costs.

Further, the grooves 63 are formed in the uppermost portions of the side portions of the key body 61, whereby the thickness dimension L1 of the uppermost portions of the side portions is made smaller than the thickness dimension L2 of the top portion of the key body 61. With this, the cooling rate difference between the portions of the top portion continuous with the side portions and the other portions of the top portion becomes difficult to be caused during molding of the key body 61, whereby it is possible to effectively suppress generation of sink marks on the top portion of the key body 61.

Note that the present invention is not limited to the above-described embodiment, but it can be practiced in various forms. For example, although in the present embodiment, the description is given of the key body 61 having the woody boards 62 attached to the side portions thereof, as shown in FIG. 11B, it is also possible to employ the weight attachment structure according to the present invention in a key body 61a having no woody boards attached to side portions thereof. In the case of the key body 61a shown in FIG. 11B, since left and right ends of a top portion thereof are not formed to protrude laterally from the side portions, the cooling rate difference caused during molding of the key body 61a between the portions of the top portion continuous with the side portions and the other portions of the top portion is small, and there is a very small possibility that sink marks are generated on the top portion. In this case, locations where grooves 63a are formed are not limited to the uppermost portions of inner surfaces of the side portions, but the grooves 63a can be formed at desired locations of the side portions. Further, since there is no need to cause the grooves 63a to extend long along the front-rear direction of the inner surfaces of the side portions as a countermeasure against generation of sink marks, the grooves 63a may be formed only at locations where the weight 64 is required to be fixed. For example, the grooves 63a may be formed only anywhere within the range of the inner space S.

It is further understood by those skilled in the art that the foregoing are preferred embodiments of the invention, and that various changes and modifications may be made without departing from the spirit and scope thereof.

What is claimed is:

1. A key for a keyboard device, comprising:
a key body made of resin, the key body having at least a top portion and a pair of side portions and formed into a hollow shape open downward, the key body extending a predetermined length in a front-rear direction, and
a weight formed of an elastically deformable material and accommodated in a predetermined position inside the key body having the hollow shape,
wherein the key body has one or a plurality of grooves extending in the front-rear direction, in an inner surface of each of the pair of the side portions, and
wherein the weight has one or a plurality of engagement protrusions each formed at a location opposed to the one or each of the plurality of grooves, when the weight is in the predetermined position, the one or each of the engagement protrusions being engaged with the one or each of the plurality of grooves, respectively, thereby holding the weight inside the key body.

2. The key according to claim 1, wherein the one or each of the plurality of grooves is formed in an uppermost portion of each of the pair of the side portions, and
wherein the uppermost portion of each of the pair of the side portions is formed to have a thickness dimension smaller than a thickness dimension of the top portion of the key body.

3. The key according to claim 1, wherein the one or each of the engagement protrusions of the weight is formed to have a vertical length dimension smaller than a vertical length dimension of the one or each of the plurality of grooves.
